(19) United States
(12) Patent Application Publication
(10) Pub. No.: US 2007/0174096 A1
(43) Pub. Date: Jul. 26, 2007

(54) Systems and methods for providing health insurance coverage

(76) Inventors: Steven J. Cain, Mequon, WI (US); Kenneth D. Beckman, Glencoe, IL (US); Jean M. Smith, Waukesha, WI (US); Kimberly S. Pollard, Mequon, WI (US); Rajeev Bal, Mequon, WI (US); Scott Krienke, Delafield, WI (US); Kaye E. Cingle, Milwaukee, WI (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/484,554

(22) Filed: Jul. 11, 2006

Related U.S. Application Data
(60) Provisional application No. 60/760,894, filed on Jan. 20, 2006.

(51) Int. Cl. G06Q 40/00

(52) U.S. Cl. 705/4

(57) ABSTRACT

The present invention provides a system that quickly and efficiently supplies an applicant with application questions that are dynamically tailored to a particular applicant, decides whether to offer the applicant long term health insurance coverage and terms of the offer, and equips an agent with information necessary to provide a more accurate quote to the applicant. Various embodiments of the present invention provide applicants with an appropriate number of questions depending on the extensiveness and type of their medical history and conditions and may provide an offer or notice of no offer of long-term coverage within a few seconds to a few hours.

### RELATED APPLICATION DATA

This application is claims the benefit of U.S. Provisional Application No. 60/760,894, filed Jan. 20, 2006, which is incorporated herein by reference in its entirety.

### FIELD OF INVENTION

This invention relates to systems and methods for providing health insurance coverage, and more specifically for quickly and efficiently obtaining an applicant's medical information and determining whether to offer, and the terms of, a long-term health insurance policy.

### BACKGROUND OF THE INVENTION

Selling and underwriting health insurance often involves obtaining information from an applicant and using that information to determine a variety of components related to insurance polices. For instance, the applicant information may be used to determine the risk associated with the particular applicant, the terms and type of policy the underwriter is willing to offer the applicant, and the premium charged to the applicant. This process traditionally requires an applicant to provide answers to a relatively large number of questions about their health history and status. Normally, most of the questions do not apply to a particular applicant and needlessly increases the amount of time the applicant spends applying for a policy. The majority of the questions are utilized to identify those few applicants in whom the questions apply.

During traditional long-term health insurance applications, generally a health insurance agent (or seller) assists the applicant in filling out the questionnaire and sending the questionnaire to an underwriter. Often, applicants request quotes from the agent regarding the premium amount. Since the traditional application contains a relatively large number of questions, the answers being of varying importance to an underwriter for determining the policy terms, an agent is generally not able to accurately provide a quote to the applicant.

After the applicant, with agent assistance, sends the completed application to an underwriter, current long-term health insurance systems require several days to several weeks to determine whether to offer coverage to the applicant and, if coverage is offered, the terms of the policy. An underwriter reviews all the answers to the questions and compares the results to various criteria parameters that assist the underwriter in deciding whether to offer long-term health coverage and the terms of the policy. Once the underwriter decides to offer coverage, the terms are sent to the agent or applicant for acceptance.

The applicant is often disadvantaged in several ways during the traditional long-term health insurance process. For instance, an applicant must wait several days or weeks to find out whether the underwriter will offer them a long-term health insurance policy. Furthermore, the applicant does not know the likely amount of the policies since the agent is not able to provide an accurate estimate of the premium due to the large number of questions that may be weighted differently. In addition, a relatively healthy applicant must be submitted to a needlessly intrusive process and spend more time than is necessary to enable the relatively healthy applicant to receive an offer for coverage. Therefore, a system and method for providing long-term health insurance offers to applicants is needed that is relatively easy to understand and that dynamically tailors the application to a particular applicant in order to provide the underwriters with sufficient health information, the agent with the ability to provide a more accurate quote, and the applicant with a relatively quick process.

### SUMMARY OF THE INVENTION

The present invention, therefore, provides a system that quickly and efficiently supplies an applicant with application questions that are dynamically tailored to a particular applicant, decides whether to offer the applicant long term health insurance coverage and terms of the offer, and equips an agent with information necessary to provide a more accurate quote to the applicant. Various embodiments of the present invention provide applicants with an appropriate number of questions depending on the extensiveness and type of their medical history and conditions and may provide an offer or notice of no offer of long-term coverage within a few seconds to a few hours.

In embodiments of the present invention, a relatively small number of health questions are supplied to the applicant. The applicant provides an answer to the first question and based upon the answer may be automatically asked an additional question related to, but more specific than, the first question or asked the next question from a predetermined set of questions. If the applicant is asked the additional question she may be asked another related, but more specific, question or asked the next question in the original list. This dynamic loop may occur as many times as necessary for the applicant to provide sufficient information regarding her health history. Therefore, under various embodiments of the present invention, a relatively healthy applicant need only answer a relatively small number of questions to complete the application, while even a relatively unhealthy applicant would still be required to answer fewer questions than with current applications.

Various embodiments of the present invention also provide automatic approval of relatively healthy applicants that do not raise any health issues through the application or in a medical information background search. Alternatively, an underwriter may review the tailored application and any medical information background search results and quickly decide whether to offer insurance coverage to the applicant.

In certain alternative embodiments of the present invention, a relatively small number of health questions are provided to an applicant. The questions are received by the underwriter and, based on the answers, the underwriter may either present follow-up questions or perform a medical background check on the applicant. If the results of the background check fall within pre-set criteria, the applicant may be approved for a policy within a relatively short amount of time.

If the answers to the first set of questions require follow-up questions, a second batch of questions, tailored based on the answers to the first set of questions, may be presented to an applicant to obtain concentrated information regarding possible health issues affecting health insurance premiums. The underwriter receives answers to the second batch of questions and determines whether additional follow-up questions are necessary to provide a premium rate offer. If no follow-up questions are necessary, a medical background check is performed and, if the medical background check results are within pre-set criteria, an offer for health insurance coverage is provided to the applicant. If follow-up questions are necessary, the applicant is again presented with additional questions that are narrowly tailored, based on answers to previous questions, to the particular applicant's medical history.

In some alternative embodiments, an underwriter reviews an application and, based on the answers, contacts the applicant for additional specific information. The applicant requiring a follow-up however still spent less time completing the application of the present invention than conventional applications since they likely were not required to answer each question.

An advantage of certain aspects and embodiments of the present invention is to provide a system and method for obtaining medical history data in order to determine long-term medical insurance coverage that is relatively less intrusive to applicants.

A further advantage of certain aspects and embodiments of the present invention is to provide a system and method for obtaining medical history data in order to determine long-term medical insurance coverage that is relatively quick and easy to understand.

A still further advantage of certain aspects and embodiments of the present invention is to provide an automated system and method for determining long-term medical insurance coverage.

A still further advantage of certain aspects and embodiments of the present invention is to provide a system and method for determining long-term medical insurance coverage that equips the agent with the ability to provide applicants with a more accurate estimate of the costs and terms of the coverage.

### BRIEF DESCRIPTION OF THE DRAWINGS

FIG. 1 schematically shows a flow diagram of receiving applicant information and deciding whether to offer a long-term medical insurance policy according to one embodiment of the present invention.

FIG. 2 schematically shows a system for deciding whether to offer a long-term medical insurance policy according to one embodiment of the present invention.

FIG. 3 schematically shows a flow diagram for providing questions that dynamically tailor to a particular applicant according to one embodiment of the present invention.

FIGS. 4-6 are screenshots of questions related to personal and qualifying information according to one embodiment of the present invention.

FIG. 7 is a screenshot of medical history questions and answers from a relatively healthy applicant according to one embodiment of the present invention.

FIG. 8 is a screenshot of medical history questions and answers with a second question related to one area of an applicant's medical history according to one embodiment of the present invention.

FIGS. 9-12 are screenshots of medical history questions with additional questions provided based on an applicant's answers according to one embodiment of the present invention.

### DETAILED DESCRIPTION OF THE INVENTION

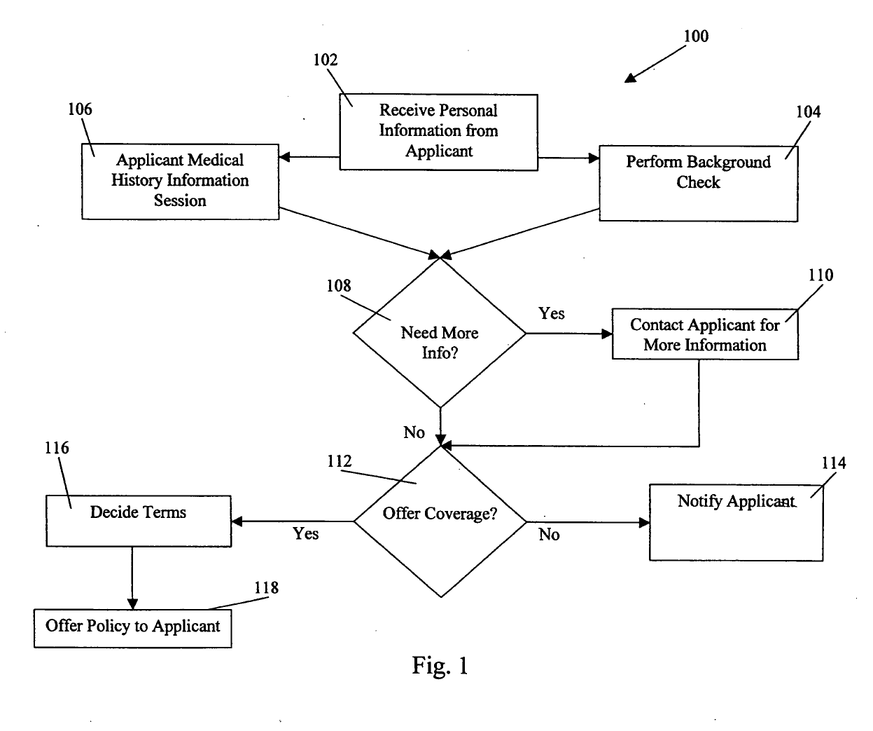

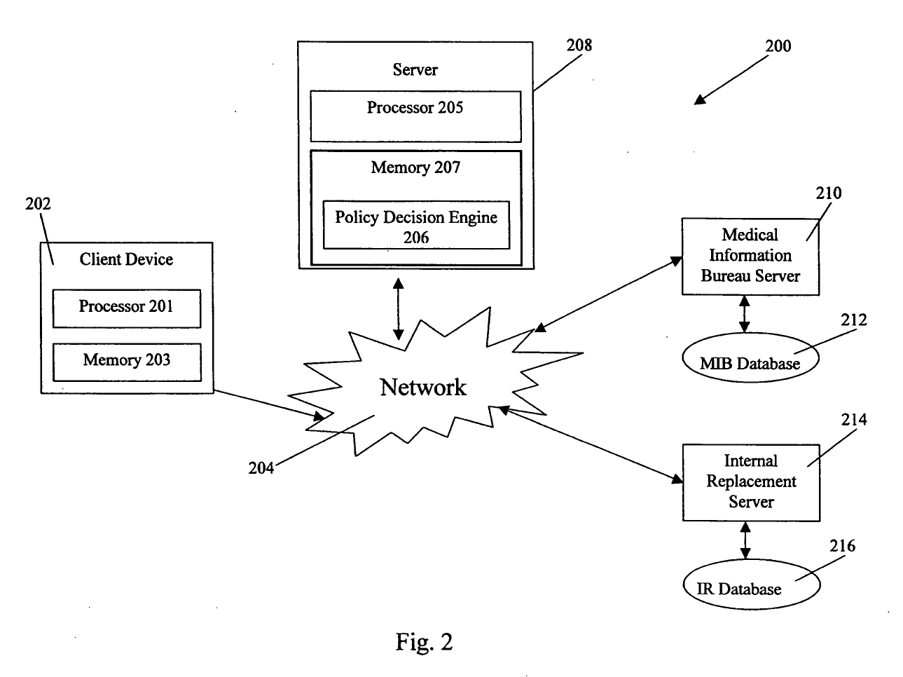

Referring initially to FIG. 1, a flow diagram 100 illustrating an exemplary sales and underwriting method for health insurance coverage. In such method applicant information is received and a decision is made as to whether to offer a long-term medical insurance policy to the applicant. This method may be automated and the exchange of information may occur electronically, such as via the Internet, and the decision making may also be performed electronically, such as by software running on computers. The method may be partially automated in that some of the exchange of information occurs electronically with some human intervention and decision making. The method may also be performed manually with little or no electronic exchange of information or electronic decision making. FIG. 2 shows an illustrative system for carrying out the method 100.

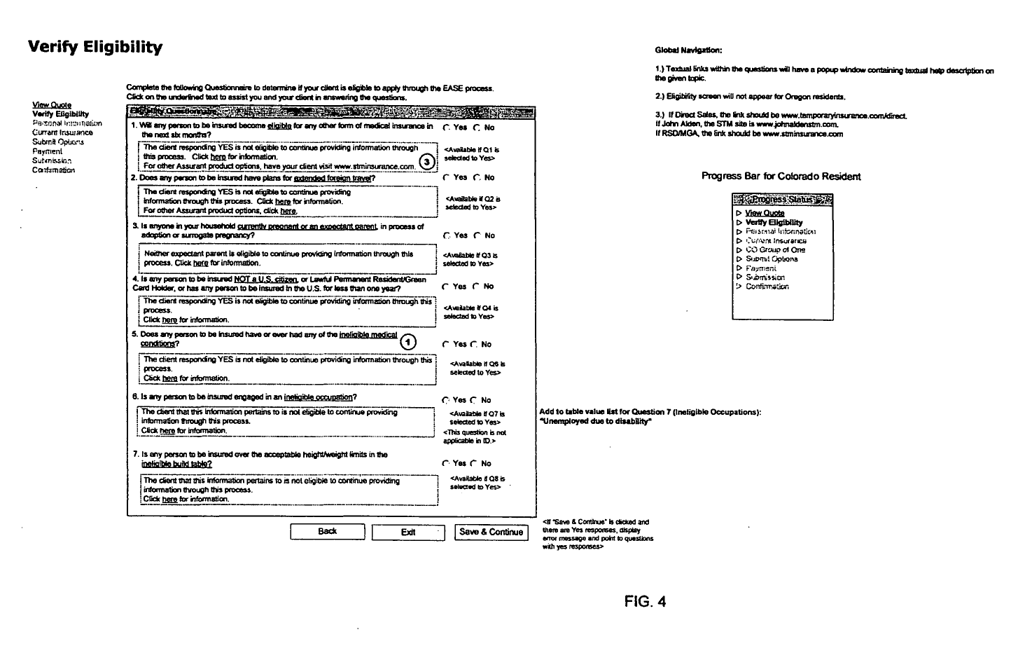

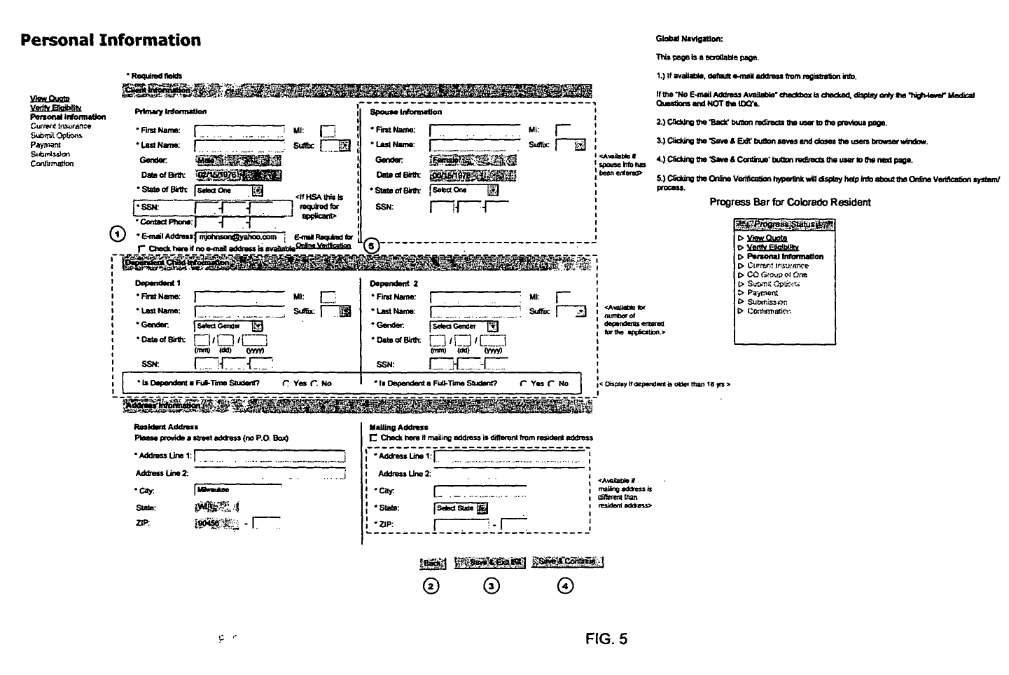

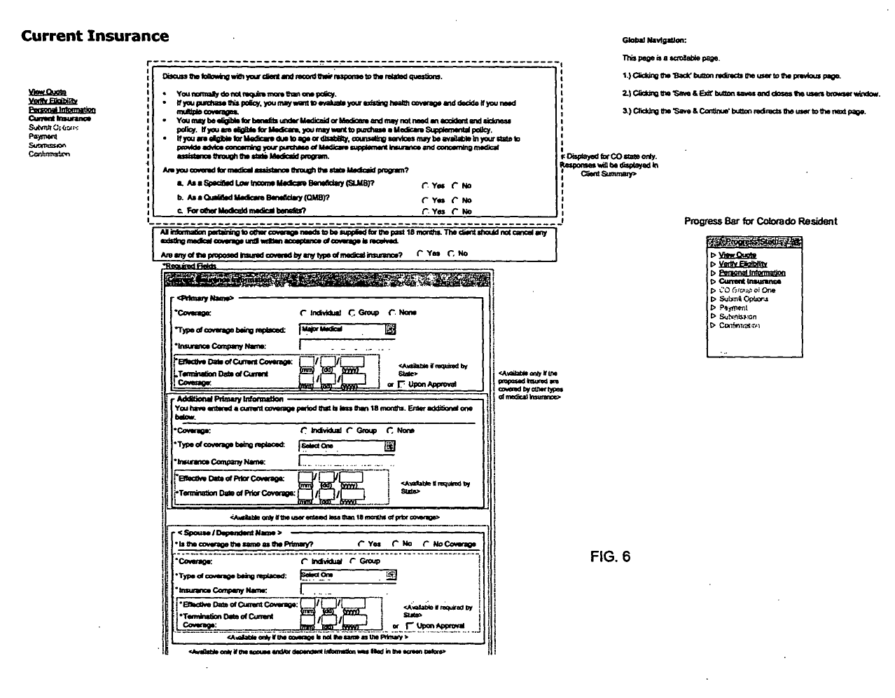

Returning now to FIG. 1, at step 102, qualifying and personal information is received from the applicant. Qualifying information may include pre-screening information that is used to determine if the applicant qualifies for health insurance coverage. Based on the qualifying information, an applicant may be initially rejected, such as if the applicant that has traveled to certain areas of the world within the last six months or the applicant that is above a certain age. Personal information may include name, contact information, social security number, and other relevant information. Personal and qualifying information may be received electronically such as via the Internet, but may also be received through any type of communication system, such as through a telecommunications network or a voice-recognition system. Examples of qualifying and personal information requests are shown in FIGS. 4-6.

In preferred embodiments of the present invention, the applicant may be required to verify that the qualifying information is accurate. An example of verifying qualifying information is shown in FIG. 4.

At step 104, a medical background check is performed. The medical background check may involve obtaining the applicant's records if any from a medical database, such as the Medical Information Bureau and an Internal Replacement system (if the applicant has previously been insured by the current underwriter).

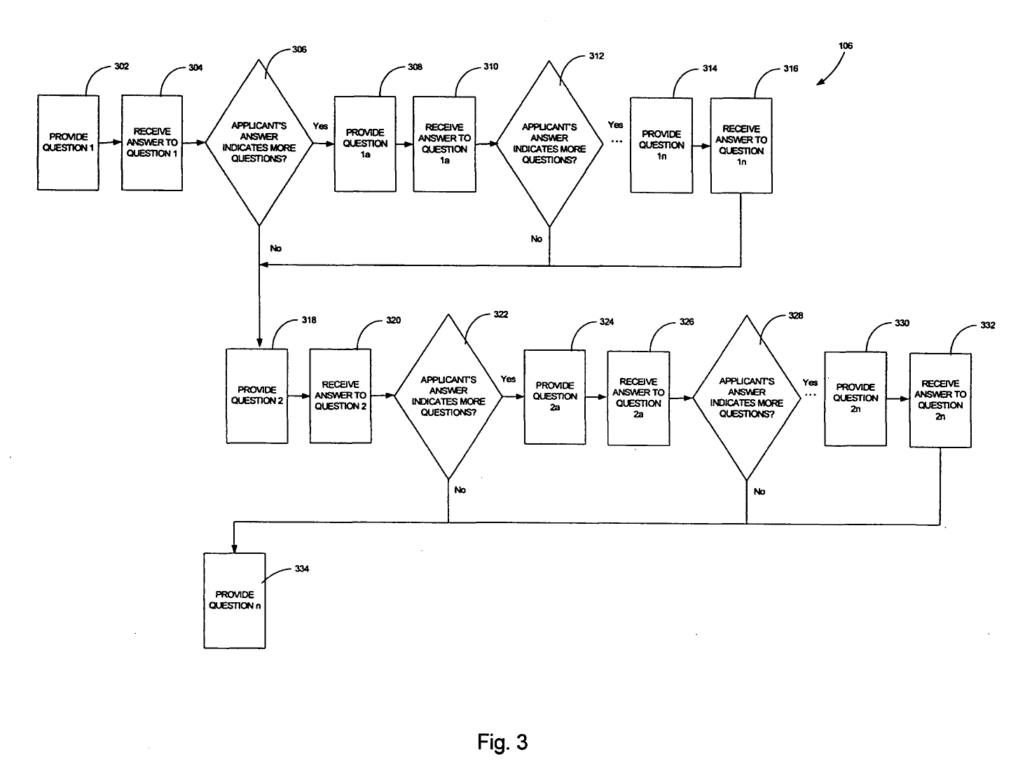

At step 106, a medical history information session occurs. The medical information session is the method by which information is obtained from the applicant regarding the applicants past medical history. For example, a predetermined set of initial questions regarding the applicant's medical history may be posed to and answered by the applicant. Based on the answers to these questions, additional follow up questions may be posed an answered. FIG. 3 below provides an illustrative medical history information session. In one embodiment, the background check of step 104 and the medical history information session 106 occur simultaneously.

At step 108, the results from the background check 104 and the applicant medical history information session 106 are collected, preferably electronically such as via a network server, and analyzed to determine if, based on the contents of the information and results from the search, the underwriter needs more information from the applicant. The analysis to determine if more information is needed 108 may be performed automatically by a processor based device by comparing the applicant medical history information session 106 and the results from the background check 104 with set criteria. Alternatively, underwriter personnel may determine whether more applicant information is needed by analyzing the data and comparing with set criteria.

If it is determined that more information is needed, at step 110 the underwriter will contact the applicant to request more information. The type of information requested may be additional details concerning a past or current medical condition or procedure or additional details concerning a result in the medical background check. Underwriter personnel may contact the applicant through any suitable means, such as via telephone. Alternatively, the applicant may be electronically contacted such as via the Internet for more information requesting the needed information.

If it is determined that no additional information is needed, at step 112 the applicant medical history information and background check results may be analyzed to determine whether the underwriter offers long-term medical insurance coverage to the applicant. The decision to offer coverage may be made by underwriter personnel after reviewing the applicant medical information and background check results and comparing to pre-set criteria. Alternatively, a processor device automatically decides whether to offer coverage by comparing the applicant medical information and background check results to pre-set criteria.

If it is decided not to offer the applicant coverage, at step 114 the applicant is notified via any suitable communication means. Examples of possible communication means could include a telecommunications system, electronic messaging, electronic mail, or by contacting the agent associated with the applicant and instructing the agent to communicate the rejection to the applicant.

If it is decided to offer the applicant long-term medical insurance coverage, then the terms of the offer are determined at step 116. The terms of the offer may include, for example, the period of coverage, the amount of the premium, the payment schedule, the exclusions of certain conditions or events, and any other subjects related to long-term medical insurance policies. Once the terms are decided, the applicant is offered the long-term medical insurance coverage, including the terms of such coverage at step 118. The offer may be communicated to the applicant via electronic communication. Alternatively, the offer 118 may be communicated through a telecommunications network or to the agent associated with the particular applicant with the agent then communicating the offer to the applicant.

FIG. 2 shows an illustrative system 200 for performing a sales and underwriting method for health insurance coverage, such as method 100 discussed above. The system 200 may include a client device 202 for the applicant to input data and information to and from devices on a network 204. In one embodiment, the client device 202 is a processor-based device such as a personal computer and having a processor 201 and a memory 203. The memory 203 may contain application programs, such as a web browser, that can access a server 208 via the network 204. The network 204 may be any type of network for communicating between two or more terminal devices. Examples of such networks 204 may include a wide area network (WAN), a local area network (LAN), or a metropolitan area network (MAN). In one embodiment, the network 204 is the Internet.

The server 208 may also be a processor-based device, such as a server, having a processor 205 and a memory 207 that can be accessed via the network 204. The memory 207 may contain software applications, such as a policy decision engine 206. The policy decision engine 206 may be in communication with client device 202, a medical information bureau server 210, and an internal replacement server 214 through the network 204. The policy decision engine 206 may include, or be able to access, application questions or pre-set criteria defining the premium rates and terms associated with various combinations of applicant medical information.

The policy decision engine 206 is capable of gathering personal information and medical history information from an applicant using the client device 202. In gathering the medical history information from an applicant, the policy decision engine 206 may present questions to the client device 202 and receive answers to the questions from the client device 202. Based on the answers, the policy decision engine 206 may determine that follow-up questions are necessary and present these to the client device 202. This process may continue until the policy decision engine 206 receives enough information from the client device 202 to decide whether to offer a long-term health insurance policy. After the necessary questions are completed, the applicant may preferably be required to verify the applicant's responses to the medical questions or the personal information.

In another embodiment, the client device 202 is in communication with another information gathering server (not shown). The information gathering server may present questions received from the policy decision engine 206 to the client device 202. For example, in one embodiment the policy decision engine provides the information gathering server with an XML file containing questions for the applicant.

The medical information bureau server 210 is preferably in communication with a medical information bureau database 212 that contains medical information on individuals that is pertinent to valuing the risk of insuring those individuals. For example, the medical information database 212 may contain, for an applicant X, information concerning a surgical procedure that may affect applicant X's long-term health. The medical information bureau server 210 preferably receives a request for information available in the medical information database 212 on a particular applicant from policy decision engine 206 through the network 204. The type of information necessary for such a search may include an applicant's date of birth, social security number, or other specifically identifiable information. The policy decision engine 206 receives the applicant identification information from the client device 202 via the network 204. After receiving and validating the request for information, the medical information bureau server 210 accesses the particular information in the medical information database 212 and communicates the information to the policy decision engine 206 via the network 204.

The policy decision engine 206 also communicates with the internal replacement server 214 through the network 204. The internal replacement server 214 is in communication with an internal replacement database 216. The internal replacement database 216 includes medical information on applicants that have previously been insured by a particular underwriting company, such as the underwriting company that is in control of the policy decision engine 206. The policy decision engine 206 requests medical information specific to the particular applicant identification information from the internal replacement server 214. The internal replacement server 214 searches the internal replacement database 216 for the medical history information concerning the particular applicant associated with the identification information. When the internal replacement server 214 finds such medical history information, the internal replacement server 214 sends the results to the policy decision engine 206 through the network 204.

The policy decision engine 206 receives the results from the medical information bureau server 210, internal replacement server 214, and the answers from the client device 202 and compares the information to criteria and policy terms. Based on the comparison, the policy decision engine 206 processor determines whether to offer a long-term medical insurance policy to a particular applicant and, if the decision is to offer a policy, the terms and premium amounts to offer. While FIG. 2 has been described above as implementing an automated process, other embodiments include manual aspects to the process. For example, underwriter personnel may pose follow-up questions to the applicant and make decisions affecting whether to offer the applicant a health insurance policy and the terms of the policy.

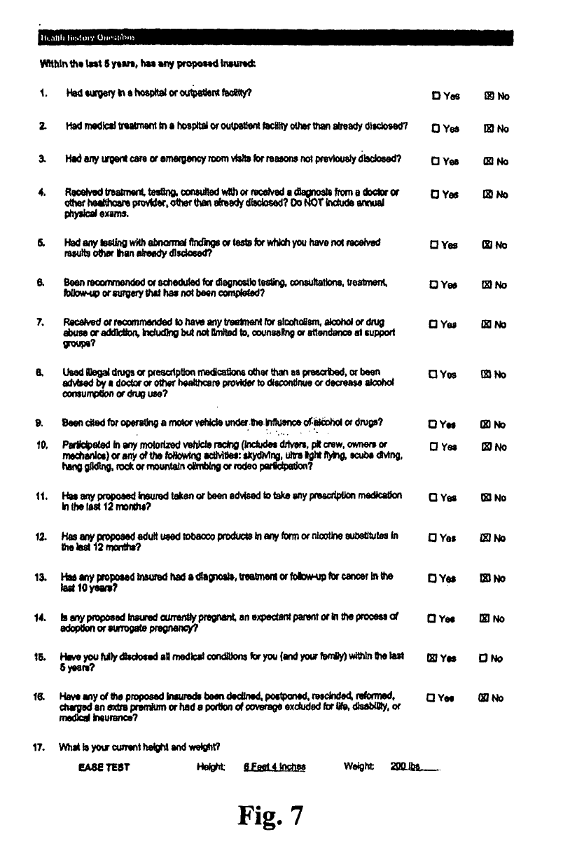

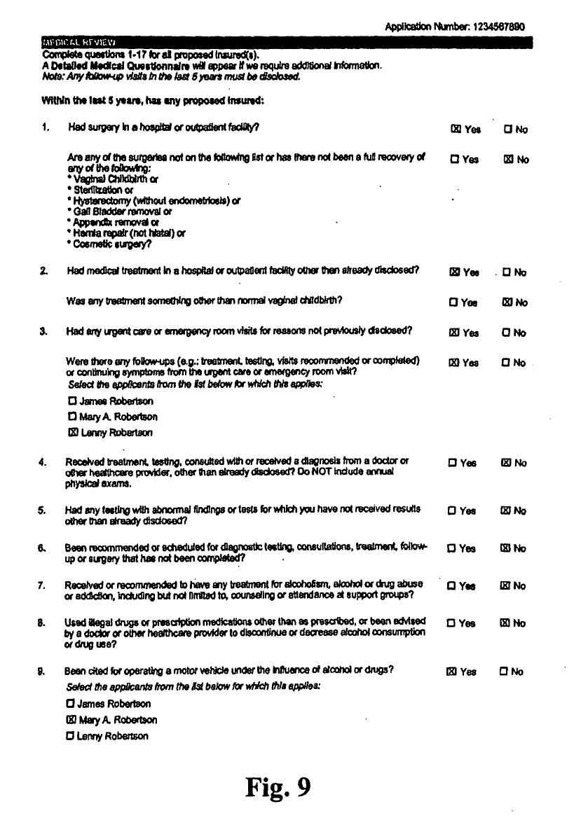

FIG. 3 shows an illustrative applicant medical history information session 106 according to one embodiment of the present invention. FIGS. 7-12 show screenshots of medical questions provided to an applicant during a medical history information session according certain embodiments of the present invention and are discussed in conjunction with the applicant medical history information session 106 illustrated in FIG. 3. Referring to FIG. 3, question 1 is first provided 302 to an applicant, preferably through a network to a client device. For example, in FIG. 7, the first question to an applicant is “within the last 5 years, has any proposed insured: had surgery in a hospital or outpatient facility?” The applicant medical history information session 106 next receives an answer to question 1 304. The answer is preferably in the form of yes or no. A determination is then made on whether the applicant's answer indicates 306 a need for more questions specifically tailored to obtain more information on the subject of the question 1 based on the answer to question 1. If the answer to question 1 does indicate more questions are needed, another question 1a 308 is provided. For example, FIG. 9 the following is displayed if question 1 is answered yes: “Are any of the surgeries not on the following list or has there not been a full recovery of any of the following:

Vaginal Childbirth or

Sterilization or

Hysterectomy (without endometriosis) or

Gall Bladder removal or

Appendix removal or

Hernia repaid (not hiatal) or

Cosmetic Surgery?”

An answer is received to question 1a 310 and another determination is made as to whether the applicant's answer indicates a need for more questions 312 related to the first two questions already provided. If there is still a need for more questions, any number of additional questions may be provided 314 and answers received 316 until sufficient information concerning subject matter of the original question 1 is received to assist in determining whether the offer a long-term medical insurance policy.

If, at any time the applicant's answer does not indicate more questions are needed 306, 312, or sufficient information concerning the subject matter of question 1 is received, the applicant medical history information session 106 provides question 2 318. For example in FIG. 7, a question 2 is provided that asks, “Within the last 5 years, has any proposed insured: had medical treatment in a hospital or outpatient facility other than already disclosed?” The applicant medical history information session 106 next receives an answer to question 2 320 that is preferably a yes or no answer. Based on the received answer to question 2 320, the applicant medical history information session 106 determines whether the applicant's answer indicates a need for more questions 322 concerning the subject matter of question 2.

If there is a need for more questions, another question 2a is provided 324 that relates to the subject matter in question 2. For example, if question 2 in FIG. 9 is answered yes, another question 2a is provided that asks, “was any treatment something other than normal vaginal childbirth?” An answer to question 2a is received 326 and then analyzed to determine whether the answer indicates a need for more questions 328. If, based on the answer, there is a need for more questions, any number of additional questions is provided 330 and answers are received 332 concerning the subject matter of question 2. This process may continue until sufficient information is received concerning question 2 to adequately determine whether to offer a long-term medical insurance policy to the applicant. If, at any time, there is no indication that more questions are needed 322, 328, or there are no more questions concerning the subject matter of question 2 left to answer, the applicant medical history information session 106 provides a next question. The process above is repeated for each question until all subject matter necessary for determining whether to offer a long-term medical insurance policy is received. As previously described, the answers to the questions are provided to the policy decision server or to underwriter personnel for analysis along with any medical information or internal search results. The analysis can determine if a policy is offered to the applicant and the terms of such an applicant.

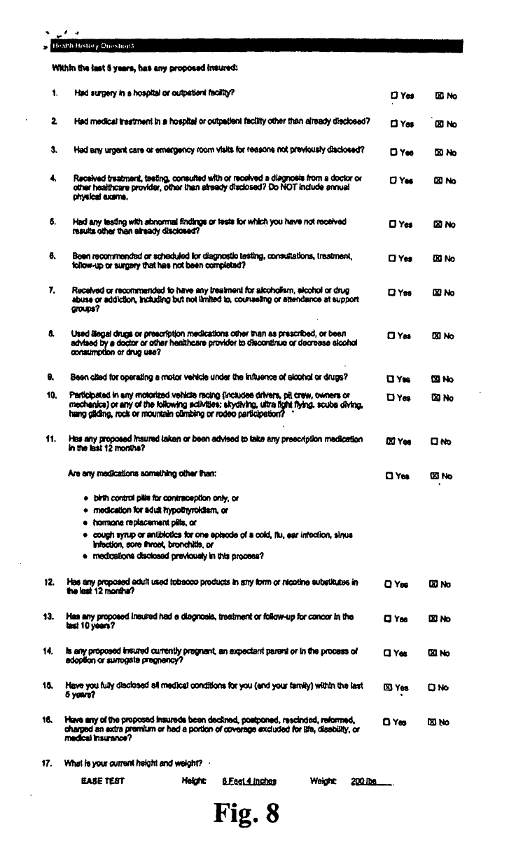

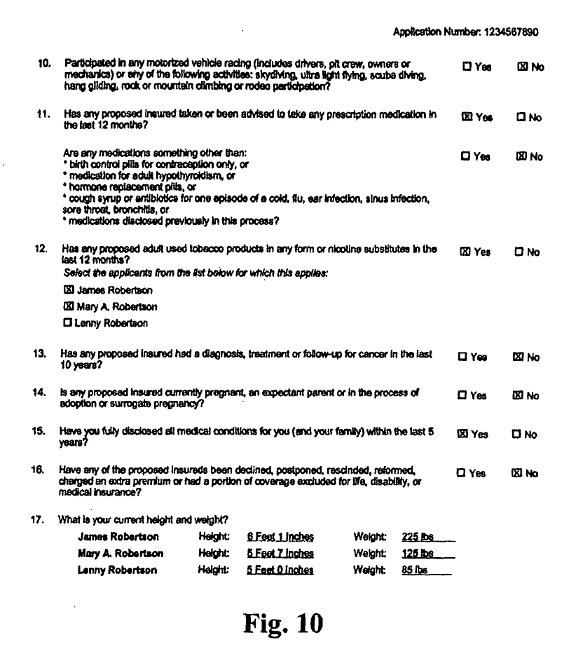

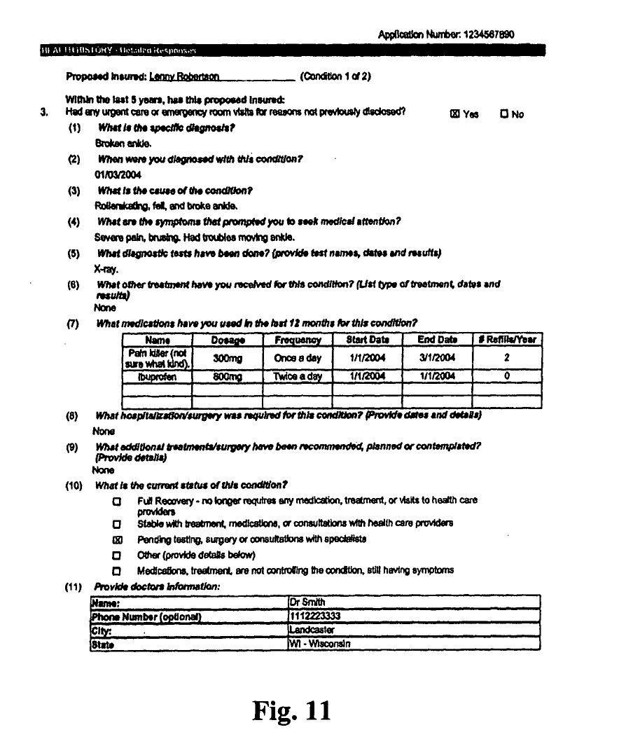

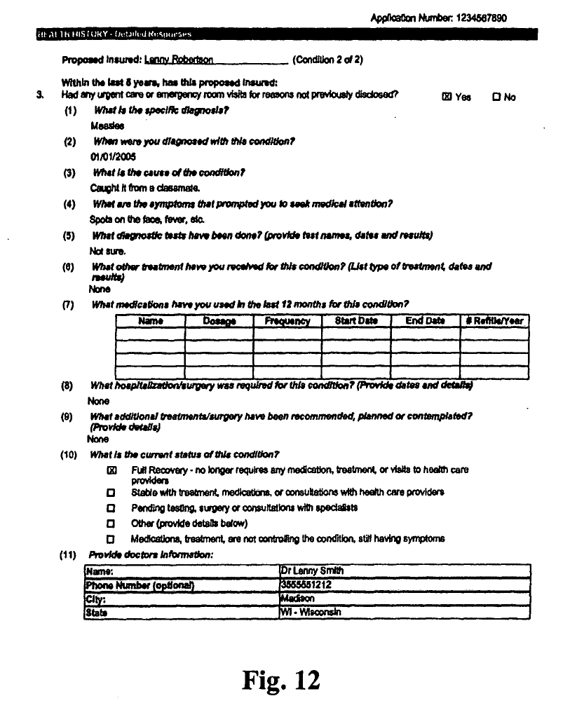

Using the process above, a relatively healthy applicant that can truthfully provide an answer to the pertinent questions that do not require additional questioning can quickly and efficiently complete the long-term medical insurance application. For example, in one embodiment shown in FIG. 7, a relatively healthy applicant may be required to only answer 17 questions if the answers to those questions indicate that no further information is needed from the applicant to determine whether to offer the applicant a health insurance policy. Even an applicant that must answer more than the general questions will still spend less time completing the application than if the applicant filled out a conventional application. For example, in the embodiment shown in FIG. 8, the applicant was required to only answer 18 questions after the applicant's answer to question 11 indicated additional information was needed. In addition, FIGS. 9-12 illustrate that even a relatively unhealthy applicant is only required to provide additional information in those areas where the applicant's answers to the initial questions indicate a need for additional information. For instance, in FIGS. 9-10, the applicant answers indicated a need for follow-up or additional related questions to question numbers 1, 2, 3, 9, 11, and 12. The Applicant was not required to answer follow-up or additional related questions to the other question numbers. Only one question required the applicant to answer more than one follow-up or additional related question. As illustrated in FIGS. 11-12, the applicant was asked a series of questions related to urgent care or emergency room visits based at least in part on the applicant's answer to question 3. Accordingly, determining whether to offer a policy and the terms of an offered policy may be made quickly and automatically utilizing various embodiments of the analysis methods described above.

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the this invention.

What is claimed is:

1. A method for applying for health insurance through a network, the method comprising:
receiving personal information associated with an applicant for health insurance through a network;
providing a first set of questions through the network, the first set questions related to the applicant's medical history and configured to be displayed on a screen;
receiving answers to the first set of questions through the network;
providing a second set of questions through the network, the second set of questions based at least in part on the answers to the first set of questions, related to the applicant's medical history, and configured to be displayed on a screen;
receiving answers to the second set of questions through the network; and
determining whether to offer the applicant a health insurance policy based at least in part on the applicant's personal information and answers to the first and second set of questions.

2. The method of claim 1, further comprising:
providing a third set of questions through the network, the third set of questions based on the applicant's answers to the second set of questions and the applicant's medical history and configured to be displayed on a screen;
receiving answers to the third set of questions through the network; and
determining whether to offer the applicant a health insurance policy based at least in part on the applicant's personal information and answers to the first, second, and third set of questions.

3. The method of claim 1, further comprising performing a medical background check based on the applicant's personal information by obtaining applicant medical history data from a database.

4. The method of claim 1, further comprising deciding the terms of an insurance offer to the applicant based on the applicant's personal information and answers to the first and second set of questions.

5. The method of claim 1, further comprising providing the applicant with an insurance policy offer through a network.

6. The method of claim 1, further comprising providing the applicant with a notification through the network that the applicant will not receive an offer.

7. The method of claim 1, wherein the applicant's personal information comprises demographic data.

8. The method of claim 7, further comprising comparing the applicant's personal information to pre-set criteria.

9. The method of claim 1, wherein the network is the Internet.

10. A method for applying for health insurance through a network, the method comprising:
providing a first question related to a first area of an applicant's medical history through a network;
receiving an answer to the first question related to a first area of an applicant's medical history through a network; and
determining whether to provide a second question that is related to the first area of the applicant's medical history based at least in part on the answer to the first question related to the first area of the applicant's medical history.

11. The method of claim 10 further comprising:
providing a second question related the first area of the applicant's medial history;
receiving an answer to the second question related to the first area of the applicant's medical history; and
determining whether to provide a third question related to the first area of the applicant's medical history based at least in part on the answer to the second question. Related to the first area of the applicant's medical history.

12. The method of claim 10 further comprising:
providing a first question related to a second area of medical insurance applicant's medial history through a network;
receiving an answer to the first question related to a second area of an applicant's medical history through a network; and
determining whether to provide a second question that is related to the second area of the applicant's medical history based at least in part on the answer to the first question related to the second area of the applicant's medical history.

13. The method of claim 10, further comprising performing a medical background check based on the applicant's personal information by obtaining applicant medical history data from a database.

14. The method of claim 13, wherein the applicant's personal information comprises demographic data.

15. The method of claim 13, further comprising comparing the applicant's personal information to pre-set criteria.

16. The method of claim 10, wherein the network is the Internet.

17. A system for applying for health insurance through a network, the system comprising:
a client device connected to a network for communicating with a server connected to the network, the client device comprising an input/output interface, processor, memory, and network interface;
the server comprising a processor, network interface, and memory having a policy decision engine and a plurality of questions related to an applicant's medical history, the policy decision engine configured to provide the client device with a first question related to a first area of an applicant's medical history through the network;
wherein the client device is configured to send answers to the first question related to a first area of an applicant's medical history to the server through the network; and
wherein the policy decision engine determines whether to provide a second question related to a first area of an applicant's medical history based at least in part on the answers to the first question related to the applicant's medical history.

18. The system of claim 17 wherein the first question related to a first area of an applicant's medical history is a set of questions.

19. The system of claim 17 wherein the second question related to a first area of an applicant's medical history is a set of questions.

20. The system of claim 17 further comprising:
a medical information bureau server configured to communicate with the server through the network;
a medical information bureau database having data and information related to the applicant's medical history and configured to communicate with the medical information bureau server;
wherein the medical information bureau server receives data and information related to the applicant's medical history from the medical information bureau database and sends the data and information to the server; and
wherein the policy decision engine determines whether to offer the applicant a health insurance policy based at least in part on the data and information from the medical information bureau server.

21. The system of claim 17 further comprising:
an internal replacement server configured to communicate with the server through the network;
an internal replacement server database having data and information related to the applicant's medical history and configured to communicate with the internal replacement server;
wherein the internal replacement server receives data and information related to the applicant's medical history from the internal replacement database and sends the data and information to the server; and
wherein the policy decision engine determines whether to offer the applicant a health insurance policy based at least in part on the data and information from the internal replacement server.

22. The system of claim 21, wherein the data and information is related to an applicant's medical history known by a particular health insurance provider.

23. The system of claim 20, further comprising:
the client device configured to send the server an applicant's personal information through the network; and
the server configured to receive the applicant's personal information, transmit the applicant's personal information to the medical information bureau server, and receive the applicant's medical history data.

24. The system of claim 23, wherein the applicant's personal information comprises demographic data.

25. The system of claim 23, wherein the policy decision engine is configured to compare the applicant's personal information to pre-set criteria.

26. The system of claim 17, wherein the policy decision engine is a software application.

27. The system of claim 17, wherein the network is the Internet.
